(19) United States
(12) Patent Application Publication
(10) Pub. No.: US 2012/0044450 A1
(43) Pub. Date: Feb. 23, 2012

(54) LIQUID CRYSTAL DISPLAY APPARATUS AND METHOD FOR MANUFACTURING THE SAME

(75) Inventors: Yoshihisa KUROSAKI, Kawasaki (JP); Toshiaki Yoshihara, Kawasaki (JP)

(73) Assignee: FUJITSU LIMITED, Kawasaki (JP)

(21) Appl. No.: 13/170,304

(22) Filed: Jun. 28, 2011

(30) Foreign Application Priority Data
Aug. 20, 2010 (JP) 2010-184768

(51) Int. Cl. G02F 1/1339; H01J 9/26

(52) U.S. Cl. 349/153; 445/25

(57) ABSTRACT

A liquid crystal display apparatus includes a first substrate and a second substrate facing each other, a liquid crystal disposed between the first substrate and the second substrate, a sealant provided between the first substrate and the second substrate, the sealant defining a space in which the liquid crystal is contained and an opening in communication with the space in association with the first substrate and the second substrate, and a sealing film covering the opening and including a first portion bonded to a surface of the first substrate and a second portion bonded to a surface of the second substrate. Portions of the first substrate and the second substrate are welded together. The portions are located on an opposite side to the opening with respect to the opening and being covered with the sealing film.

### CROSS-REFERENCE TO RELATED APPLICATION

This application is based upon and claims the benefit of priority of the prior Japanese Patent Application No. 2010-184768, filed on Aug. 20, 2010, the entire contents of which are incorporated herein by reference.

### FIELD

The embodiment discussed herein is related to a liquid crystal display apparatus and a method for manufacturing the liquid crystal display apparatus.

### BACKGROUND

In a known method for manufacturing a liquid crystal display element for use in electronic paper, after two substrates have been bonded together with a sealant, a liquid crystal is injected into a space between the substrates. For example, in a method for manufacturing a liquid crystal display element disclosed in Japanese Laid-open Patent Publication No. 05-127176, after a liquid crystal has been injected through an inlet into a space between two substrates, portions of the substrates corresponding to the inlet are heat-pressed to seal the liquid crystal space.

In the liquid crystal space of the liquid crystal display element, the portions of the substrates corresponding to the inlet are filled with the liquid crystal. Thus, the heat press bonding of the portions of the substrates corresponding to the inlet heats the liquid crystal in the vicinity of the inlet, possibly generating air bubbles in the liquid crystal space. Air bubbles in the liquid crystal space can degrade image quality and hinder the drive of the liquid crystal. Thus, elements thus manufactured must be checked for the presence of air bubbles. Once a liquid crystal display element is heat-pressed, however, air bubbles in the liquid crystal cannot be removed. Liquid crystal display elements containing air bubbles must therefore be disposed of as defective products.

### SUMMARY

According to an aspect of an embodiment, a liquid crystal display apparatus includes a first substrate and a second substrate facing each other, a liquid crystal disposed between the first substrate and the second substrate, a sealant provided between the first substrate and the second substrate, the sealant defining a space in which the liquid crystal is contained and an opening in communication with the space in association with the first substrate and the second substrate, and a sealing film covering the opening and including a first portion bonded to a surface of the first substrate and a second portion bonded to a surface of the second substrate. Portions of the first substrate and the second substrate are welded together. The portions are located on an opposite side to the opening with respect to the opening and being covered with the sealing film.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a partly cutaway plan view of a liquid crystal display apparatus according to a first embodiment.

FIG. 2 is a plan view of a liquid crystal display element according to the first embodiment.

FIG. 3 is a partly cutaway plan view of the liquid crystal display element according to the first embodiment.

FIG. 4 is a plan view of a liquid crystal inlet portion according to the first embodiment.

FIG. 5 is a cross-sectional view taken along the line V-V in FIG. 4.

FIG. 6 is a plan view of a liquid crystal inlet portion according to a modification of the first embodiment.

FIG. 7 is a plan view of a liquid crystal inlet portion according to another modification of the first embodiment.

FIG. 8 is an explanatory drawing of a process for manufacturing the liquid crystal display element according to the first embodiment.

FIG. 9 is an explanatory drawing of a process for manufacturing the liquid crystal display element according to the first embodiment.

FIG. 10 is an explanatory drawing of a process for manufacturing the liquid crystal display element according to the first embodiment.

FIG. 11 is an explanatory drawing of a process for manufacturing the liquid crystal display element according to the first embodiment.

FIG. 12 is an explanatory drawing of a process for sealing a liquid crystal inlet according to the first embodiment.

FIG. 13 is a cross-sectional view of the liquid crystal inlet portion in the process for sealing a liquid crystal inlet according to the first embodiment.

FIG. 14 is a cross-sectional view of a liquid crystal inlet portion according to another modification of the first embodiment.

FIG. 15 is a perspective view of welding heads according to a modification of the first embodiment.

FIG. 16 is a partly cutaway plan view of a liquid crystal display element according to a second embodiment.

FIG. 17 is a plan view of a liquid crystal inlet portion according to the second embodiment.

FIG. 18 is a cross-sectional view taken along the line XVIII-XVIII in FIG. 17.

FIG. 19 is a plan view of a liquid crystal inlet portion according to a modification of the second embodiment.

FIG. 20 is a plan view of a liquid crystal inlet portion according to another modification of the second embodiment.

FIG. 21 is a cross-sectional view of the liquid crystal inlet portion according to that other modification of the second embodiment.

### DESCRIPTION OF EMBODIMENTS

### First Embodiment

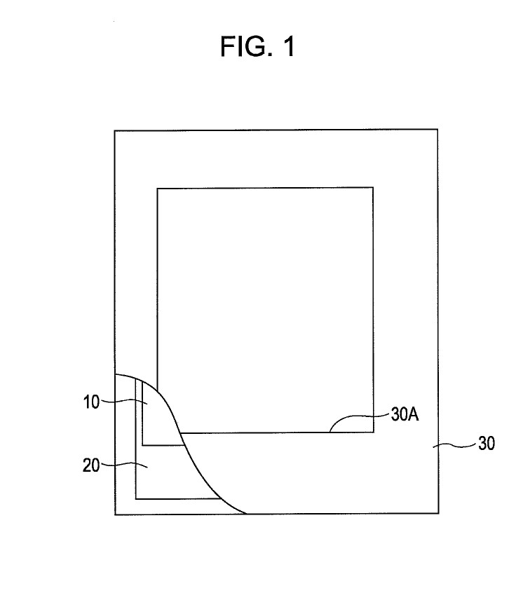

A first embodiment will be described below with reference to FIGS. 1 to 15.

Structure of Liquid Crystal Display Apparatus

FIG. 1 is a partly cutaway plan view of a liquid crystal display apparatus according to the first embodiment. The liquid crystal display apparatus may be electronic paper. The liquid crystal display apparatus includes a liquid crystal display element 10, a circuit board 20, and a housing 30. Although the liquid crystal display apparatus according to the present embodiment includes only one liquid crystal display element 10, color liquid crystal display apparatuses may include three liquid crystal display elements for red, green, and blue.

The liquid crystal display element 10 is connected to the circuit board 20 through a flexible printed circuit (not shown). As viewed from the top, the liquid crystal display element 10 overlaps with the circuit board 20 with a backlight (not shown) interposed therebetween. The housing 30 contains the liquid crystal display element 10, the circuit board 20, and the backlight. The housing 30 has an opening 30A, which faces the liquid crystal display element 10 and defines the display screen.

Structure of Liquid Crystal Display Element

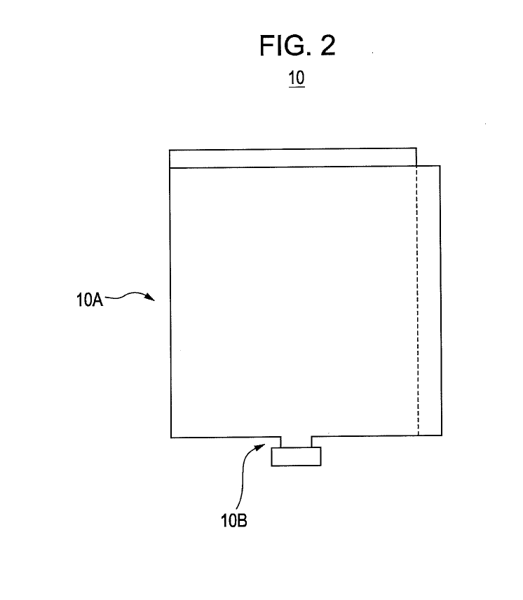

FIG. 2 is a plan view of the liquid crystal display element 10 according to the first embodiment. The liquid crystal display element 10 includes a liquid crystal display portion 10A and a liquid crystal inlet portion 10B, which has a smaller width than the liquid crystal display portion 10A. The liquid crystal display portion 10A drives a liquid crystal L (not shown) in a liquid crystal space S to display information. The liquid crystal inlet portion 10B protrudes from the liquid crystal display portion 10A. The liquid crystal L is injected through the liquid crystal inlet portion 10B into the liquid crystal space S of the liquid crystal display portion 10A.

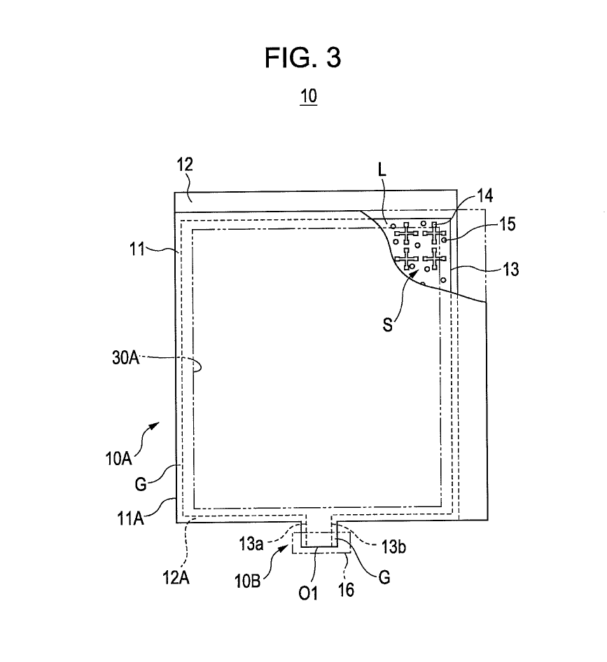

FIG. 3 is a partly cutaway plan view of the liquid crystal display element 10 according to the first embodiment. The liquid crystal display element 10 includes a first film substrate 11 and a second film substrate 12. For example, the first film substrate 11 and the second film substrate 12 are made of poly(ethylene terephthalate) (PET), polycarbonate (PC), poly(ethylene naphthalate) (PEN), or polyethersulfone (PES). These materials may have a melting point in the range of 130° C. to 150° C. The first film substrate 11 and the second film substrate 12 are bonded together with a sealant 13 so as to be a predetermined distance from each other. The distance between the first film substrate 11 and the second film substrate 12 depends on the dimensions of columnar spacers 14 and spherical spacers 15 described below. For example, the distance ranges from approximately 4 to 5 μm.

A plurality of transparent electrodes (not shown) and alignment films (not shown) are disposed on the surfaces of the first film substrate 11 and the second film substrate 12 facing the liquid crystal L. A driving voltage can be applied to the liquid crystal L through the transparent electrodes. The alignment films allow the liquid crystal L to be oriented. The transparent electrodes may be made of indium tin oxide (ITO).

The alignment films cover the first film substrate 11, the second film substrate 12, and the transparent electrodes. The surfaces of the alignment films have been subjected to a rubbing process to facilitate the orientation of the liquid crystal L in the vicinity of the first film substrate 11 and the second film substrate 12. The alignment films may be made of polyimide.

The columnar spacers 14 and the spherical spacers (for example, bead spacers) 15 are disposed between the first film substrate 11 and the second film substrate 12. The liquid crystal space S between the first film substrate 11 and the second film substrate 12 is filled with the liquid crystal L.

The columnar spacers 14 are shaped like a cross as viewed from the top and are disposed between the transparent electrodes. The columnar spacers 14 may have a height in the range of approximately 4 to 5 μm. The columnar spacers 14 are sticky and can adhere to the first film substrate 11 and the second film substrate 12. Thus, the columnar spacers 14 prevent an increase and a decrease in the distance between the first film substrate 11 and the second film substrate 12. The columnar spacers 14 may be made of an acrylic photoresist.

The spherical spacers 15 are dispersed between the first film substrate 11 and the second film substrate 12. The spherical spacers 15 may have a diameter in the range of 4 to 5 μm. The spherical spacers 15 may be made of a vitreous material or an acrylic resin material. The material of the liquid crystal L has a decomposition temperature or a temperature at which the thermal decomposition of the liquid crystal L causes gas evolution higher than the melting points of the materials of the first film substrate 11 and the second film substrate 12. The liquid crystal L may be a cholesteric liquid crystal. The cholesteric liquid crystal may have a decomposition temperature in the range of approximately 170° C. to 180° C.

The columnar spacers 14, the spherical spacers 15, and the liquid crystal L are uniformly disposed in not only the liquid crystal display portion 10A, but also the liquid crystal inlet portion 10B. Thus, also in the liquid crystal inlet portion 10B, there is a space between the first film substrate 11 and the second film substrate 12, and the space is filled with the liquid crystal L.

The sealant 13 is disposed along the peripheries of the first film substrate 11 and the second film substrate 12 and defines the liquid crystal space S to be filled with the liquid crystal L. A first end 13a and a second end 13b of the sealant 13 extend from the liquid crystal display portion 10A to the liquid crystal inlet portion 10B and define a liquid crystal inlet O1 through which the liquid crystal L can be injected into the liquid crystal space S. For example, the sealant 13 can be formed by the application of an adhesive with a dispenser. The adhesive may be an acrylic resin material.

The sealant 13 is disposed slightly away from the peripheries of the first film substrate 11 and the second film substrate 12. Thus, the first film substrate 11 and the second film substrate 12 have a first substrate outer-area 11A and a second substrate outer-area 12A, respectively, outside the sealant 13.

The first substrate outer-area 11A and the second substrate outer-area 12A are disposed along the entire peripheries of the first film substrate 11 and the second film substrate 12, forming a gap G between the first film substrate 11 and the second film substrate 12. The gap G has approximately the same thickness as the liquid crystal space S. The formation of the first substrate outer-area 11A and the second substrate outer-area 12A depends on the method for manufacturing the liquid crystal display element 10.

In the manufacture of the liquid crystal display element 10, two large sheets are bonded together with the sealant 13 to form a large-size sheet. The large-size sheet is then cut, for example, by a punching method into the liquid crystal display element 10. The contact between a blade used in the punching method and the sealant 13 may produce undesired asperities on the surface of the sealant 13. Furthermore, the sealant 13 may become detached from the large-size sheet. The large-size sheet is therefore cut at a position sufficiently away from the sealant 13. This forms blank spaces of the first film substrate 11 and the second film substrate 12 outside the sealant 13, that is, the first substrate outer-area 11A and the second substrate outer-area 12A, thereby forming the gap G. The width of the gap G corresponds to the distance between the sealant 13 and the edges of the first film substrate 11 and the second film substrate 12, that is, the widths of the first substrate outer-area 11A and the second substrate outer-area 12A and may be approximately 200 μm.

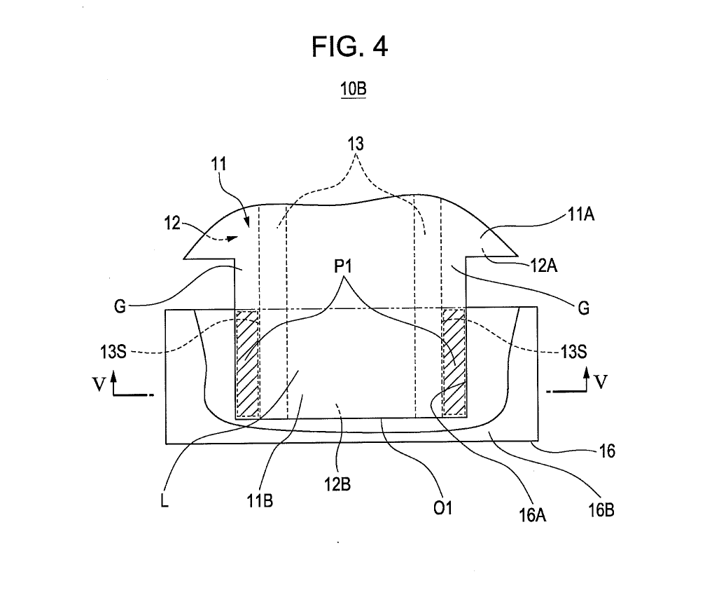

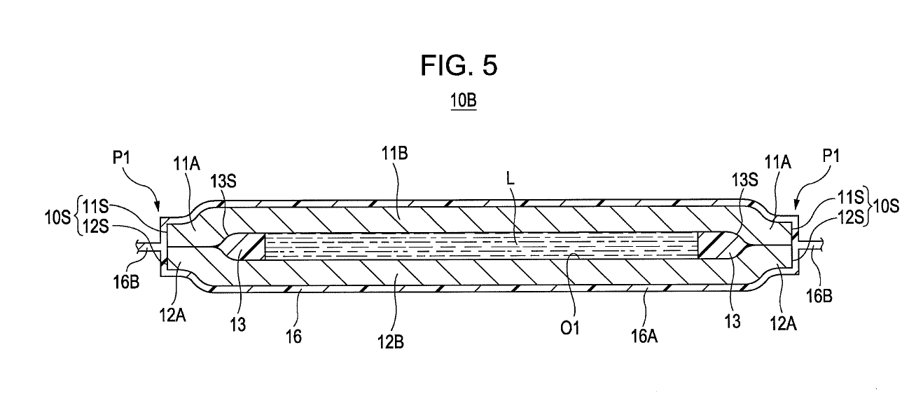

FIG. 4 is a plan view of the liquid crystal inlet portion 10B according to the first embodiment. FIG. 5 is a cross-sectional view taken along the line V-V in FIG. 4. As illustrated in FIG. 4 or 5, the first film substrate 11 and the second film substrate 12 have a first substrate inlet portion 11B and a second substrate inlet portion 12B, respectively, corresponding to the liquid crystal inlet portion 10B.

The first substrate inlet portion 11B and the second substrate inlet portion 12B are bent such that the distance therebetween decreases in the vicinity of the sealant 13. The inner surfaces of the first substrate inlet portion 11B and the second substrate inlet portion 12B adhere closely to the surface of the sealant 13 opposite the liquid crystal L, that is, an outer side surface 13S. Portions of the first substrate inlet portion 11B and the second substrate inlet portion 12B extending outside the sealant 13 are welded together to form welded portions P1. Thus, at least in the liquid crystal inlet portion 10B, the gap G between the first substrate outer-area 11A and the second substrate outer-area 12A is sealed. In each of the welded portions P1, an end face 11S of the first substrate inlet portion 11B and an end face 12S of the second substrate inlet portion 12B continuously form a side surface 10S. The hatched areas in FIG. 4 indicate the welded portions P1 between the first film substrate 11 and the second film substrate 12.

The liquid crystal inlet portion 10B of the liquid crystal display element 10 is provided with a sealing member 16 for sealing the liquid crystal inlet O1. The sealing member 16 includes two resin films and has a holding portion 16A and a peripheral portion 16B. The holding portion 16A surrounds the first substrate inlet portion 11B and the second substrate inlet portion 12B so as to include the liquid crystal inlet O1 and the welded portions P1. The peripheral portion 16B includes two resin films welded together and extends from the holding portion 16A.

The inner surface of the holding portion 16A is welded to the outer surface of the first substrate inlet portion 11B, the outer surface of the second substrate inlet portion 12B, and the side surfaces 10S of the welded portions P1 and hermetically seals the liquid crystal inlet O1. This can prevent the leakage of the liquid crystal L from the liquid crystal space S and the flow of the outside air into the liquid crystal space S.

The material of the resin films of the sealing member 16 has a lower melting point than the materials of the first film substrate 11 and the second film substrate 12. For example, the material is low-density polyethylene (LDPE) or poly(vinyl chloride) (PVC). These materials may have a melting point in the range of 100° C. to 115° C.

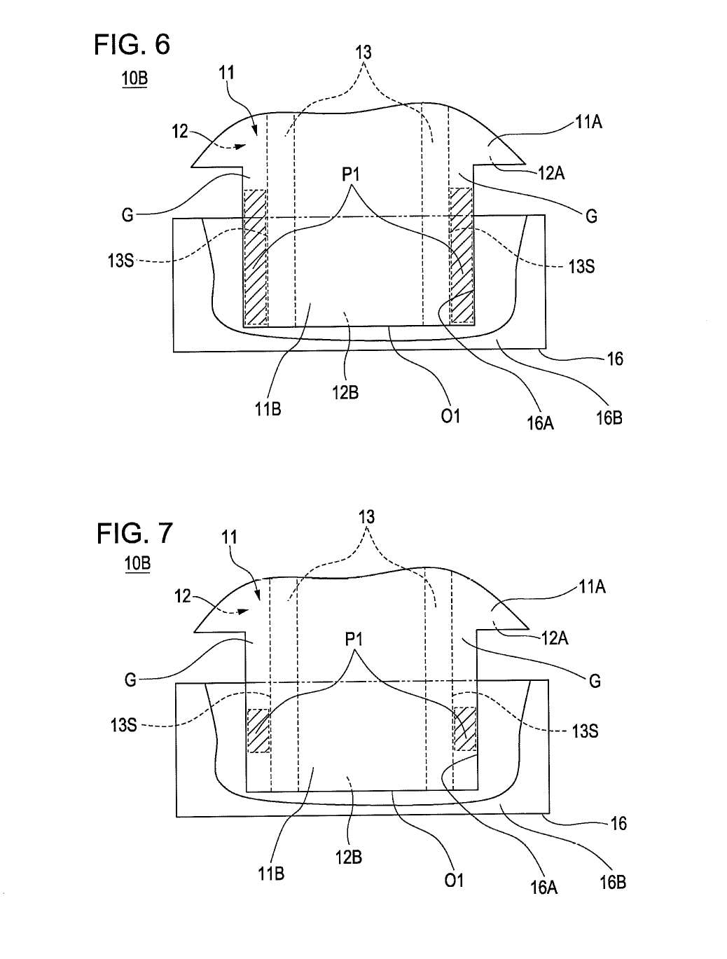

Although the welded portions P1 are formed within the holding portion 16A of the sealing member 16 in the present embodiment, the present embodiment is not limited to this structure. FIG. 6 is a plan view of a liquid crystal inlet portion 10B according to a modification of the first embodiment. As illustrated in FIG. 6, the welded portions P1 may extend from the inside to the outside of the holding portion 16A of the sealing member 16. In this case, an increased welded area between the first film substrate 11 and the second film substrate 12 allows securer sealing of the gap G between the first substrate outer-area 11A and the second substrate outer-area 12A. Alternatively, the welded portions P1 may be partly formed within the holding portion 16A of the sealing member 16. FIG. 7 is a plan view of a liquid crystal inlet portion 10B according to another modification of the first embodiment. As illustrated in FIG. 7, the welded portions P1 may be partly formed within the sealing member 16. In this case, a decreased welded area between the first film substrate 11 and the second film substrate 12 can shorten the welding time with welding heads described below.

Method for Manufacturing Liquid Crystal Display Element

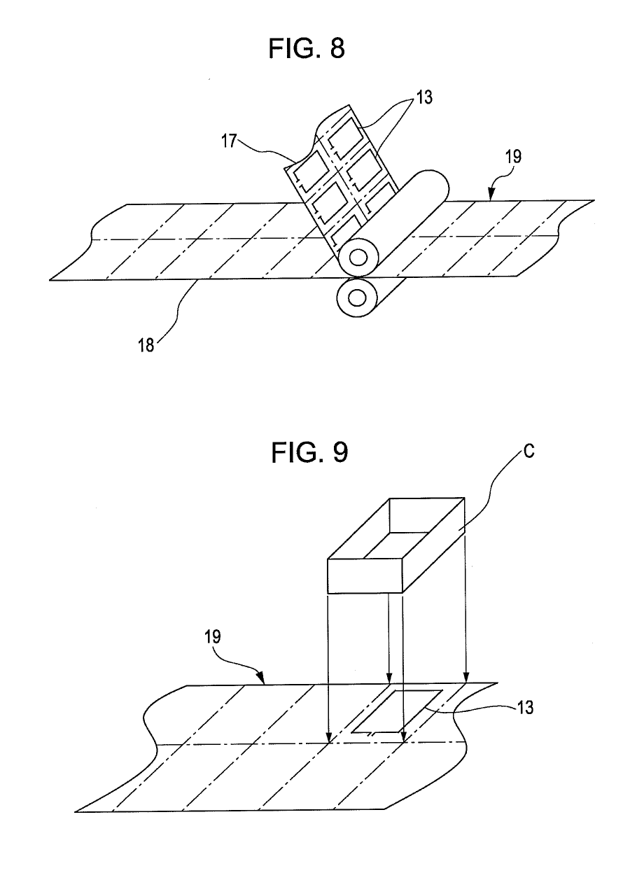

A method for manufacturing the liquid crystal display element 10 according to the first embodiment will be described below. FIGS. 8 to 11 are explanatory drawings of a process for manufacturing the liquid crystal display element 10 according to the first embodiment.

As illustrated in FIG. 8, a first sheet 17 and a second sheet 18 are prepared. Transparent electrodes (not shown) and alignment films (not shown) are formed on the first sheet 17 and the second sheet 18, respectively. The first sheet 17 and the second sheet 18 have been subjected to half-cut pretreatment in a predetermined shape. The “half-cut” pretreatment forms a portion having a reduced thickness in the first sheet 17 and the second sheet 18, for example, by laser beam irradiation.

An adhesive is then applied to areas of elements in the first sheet 17 with a dispenser to form sealants 13. Although not shown, a plurality of columnar spacers 14 and spherical spacers 15 are formed on the second sheet 18. For example, the columnar spacers 14 are formed by the application of an acrylic photoresist to the second sheet 18 and the exposure and development of the photoresist (photolithography). For example, the spherical spacers 15 are formed using a spray nozzle located above the second sheet 18. Although the sealants 13 are applied to the first sheet 17 in the present embodiment, the sealants 13 may be applied to the second sheet 18. The first sheet 17 and the second sheet 18 are then bonded together with the sealants 13 to produce a large-size sheet 19. In FIGS. 8 and 9, the sealants 13 are disposed on the back side of the first sheet 17 and should therefore be indicated by a broken line. For convenience in drawing, however, the sealants 13 are indicated by solid lines.

As illustrated in FIG. 9, the large-size sheet 19 is then punched out with a cutter C to form liquid crystal display elements 10. The cutter C is positioned such that the sections of the large-size sheet 19 are apart from the sealants 13. In other words, the cutter C is positioned such that the sections of the large-size sheet 19 do not interfere with the sealants 13. After the large-size sheet 19 is divided into the liquid crystal display elements 10, unnecessary portions of the first sheet 17 and the second sheet 18 along the half-cut line are removed.

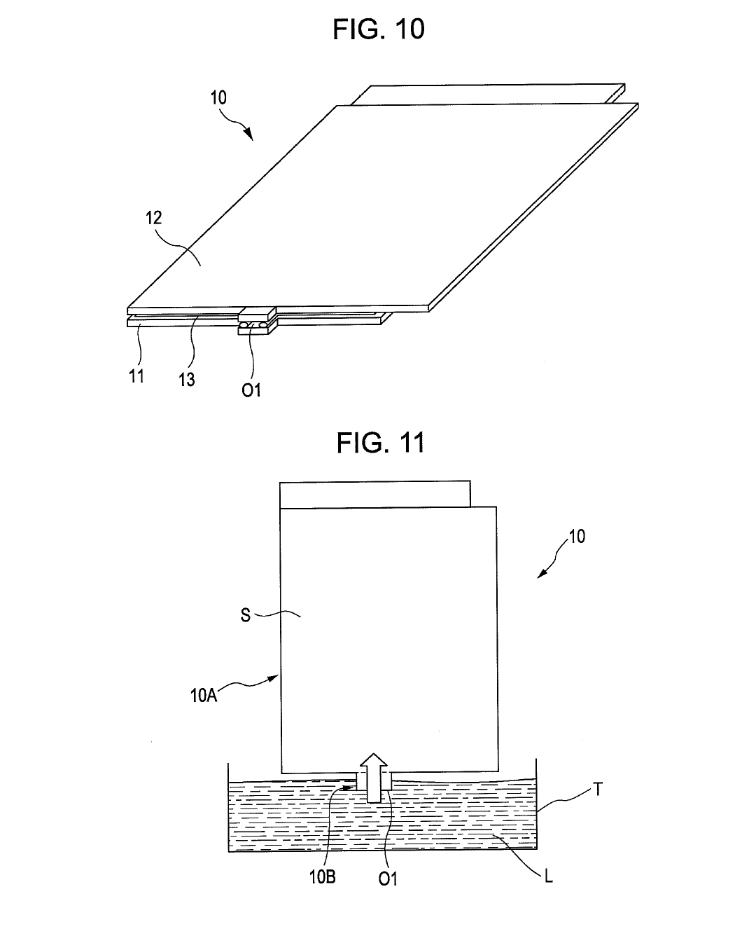

Through these processes, the liquid crystal display element 10 containing no liquid crystal L as illustrated in FIG. 10 is completed in which the first film substrate 11 and the second film substrate 12 are bonded together. In FIG. 10, the first film substrate 11 and the second film substrate 12 are different in shape because the half-cut lines on the first film substrate 11 and the second film substrate 12 are different.

The liquid crystal display element 10 containing no liquid crystal L is then placed in a vacuum chamber (not shown) to evacuate air between the first film substrate 11 and the second film substrate 12.

As illustrated in FIG. 11, the liquid crystal inlet O1 of the liquid crystal display element 10 is then immersed in the liquid crystal L in a liquid crystal tank T. The vacuum chamber is then opened to the atmosphere. This pressurizes the liquid crystal L in the liquid crystal tank T to the atmosphere, allowing the liquid crystal L to be injected into the liquid crystal space S between the first film substrate 11 and the second film substrate 12 (a vacuum pumping method). The columnar spacers 14 and the spherical spacers 15 disposed on the liquid crystal inlet portion 10B can provide a gap between the first substrate inlet portion 11B and the second substrate inlet portion 12B, allowing the liquid crystal L to be smoothly injected.

After the liquid crystal space S of the liquid crystal display element 10 is filled with the liquid crystal L, the liquid crystal inlet O1 of the liquid crystal display element 10 is sealed with the sealing member 16. Through these processes, the liquid crystal display element 10 according to the first embodiment is manufactured.

Method for Sealing Liquid Crystal Inlet

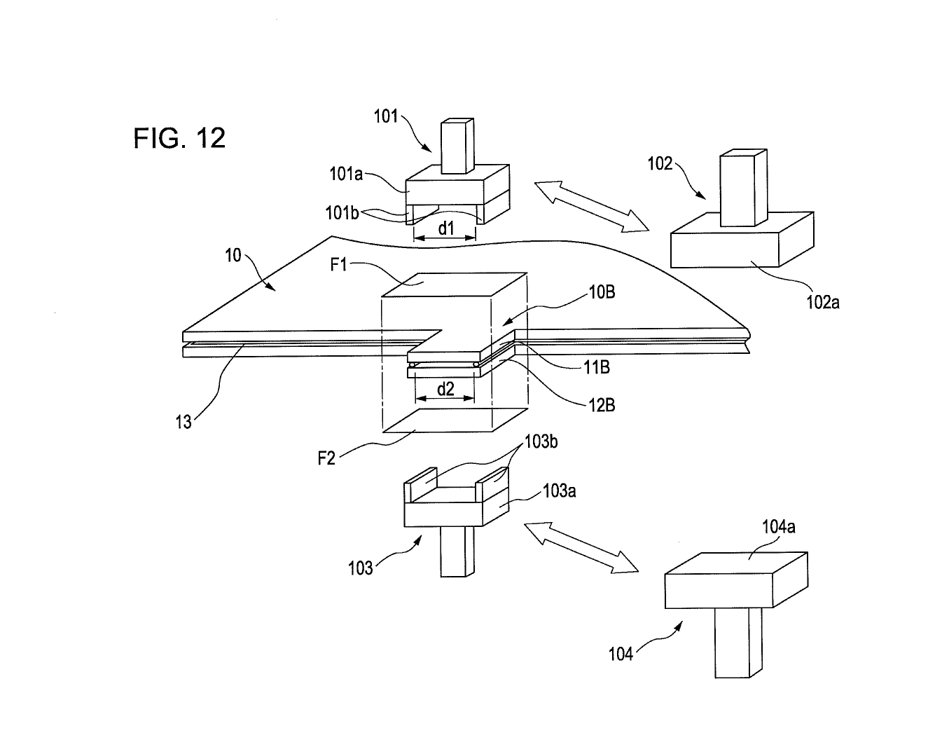

A method for sealing the liquid crystal inlet O1 of the liquid crystal display element 10 will be described below. FIG. 12 is an explanatory drawing of a process for sealing the liquid crystal inlet O1 according to the first embodiment.

As illustrated in FIG. 12, four welding heads are used to seal the liquid crystal inlet O1 of the liquid crystal display element 10 in the present embodiment. The four welding heads are a first upper welding head 101, a second upper welding head 102, a first lower welding head 103, and a second lower welding head 104. The first upper welding head 101 and the first lower welding head 103 can be used to weld the first substrate inlet portion 11B to the second substrate inlet portion 12B, forming the welded portions P1. The second upper welding head 102 and the second lower welding head 104 can be used to weld a first resin film F1 to a second resin film F2, thereby sealing the liquid crystal inlet O1.

The first upper welding head 101 includes a head main body 101a and two pressure blocks 101b disposed on the undersurface of the head main body 101a. For example, the distance d1 between the two pressure blocks 101b satisfies the equation d1=d2+2×d3, wherein d2 denotes the distance between the sealants 13 in the liquid crystal inlet portion 10B of the liquid crystal display element 10, and d3 denotes the diameter of the sealant 13.

The second upper welding head 102 has a pressure surface 102a, which has a larger area than each of the first resin film F1 and the second resin film F2.

The first lower welding head 103 has a shape and dimensions corresponding to those of the first upper welding head 101 and includes a head main body 103a and two pressure blocks 103b fixed to the top surface of the head main body 103a.

The second lower welding head 104 has a shape and dimensions corresponding to those of the second upper welding head 102 and includes a pressure surface 104a, which has a larger area than each of the first resin film F1 and the second resin film F2.

The first upper welding head 101 and the first lower welding head 103 are connected to a first oscillator (not shown). The first oscillator provides the pressure blocks 101b and 103b of the first upper welding head 101 and the first lower welding head 103 with ultrasonic vibrations.

The second upper welding head 102 and the second lower welding head 104 are connected to a second oscillator (not shown). The second oscillator provides the pressure surfaces 102a and 104a of the second upper welding head 102 and the second lower welding head 104 with ultrasonic vibrations. The amplitude or frequency of ultrasonic vibrations generated by the first oscillator is different from the amplitude or frequency of ultrasonic vibrations generated by the second oscillator.

In the present embodiment, the amplitudes or frequencies of ultrasonic vibrations generated by the first oscillator and the second oscillator are determined such that the temperature at which the first substrate inlet portion 11B and the second substrate inlet portion 12B are welded together to form the welded portions P1 is higher than the temperature at which the first resin film F1 and the second resin film F2 are welded together to seal the liquid crystal inlet O1.

When the liquid crystal inlet O1 of the liquid crystal display element 10 is sealed using the welding heads 101 to 104, the liquid crystal display element 10 is first placed on a table (not shown). The table is then moved to locate the liquid crystal display element 10 at a predetermined position.

The first upper welding head 101 and the first lower welding head 103 are then moved to position the pressure blocks 101b and the pressure blocks 103b along the outsides of the sealants 13 in the liquid crystal inlet portion 10B of the liquid crystal display element 10. The first resin film F1 and the second resin film F2 are then placed above and below the liquid crystal inlet portion 10B of the liquid crystal display element 10, respectively. The first resin film F1 and the second resin film F2 are rectangular and can sufficiently cover the liquid crystal inlet portion 10B.

The first resin film F1, the second resin film F2, the first substrate inlet portion 11B, and the second substrate inlet portion 12B are then pressurized with the first upper welding head 101 and the first lower welding head 103. The first oscillator is then operated to apply ultrasonic vibrations to the pressure blocks 101b and 103b.

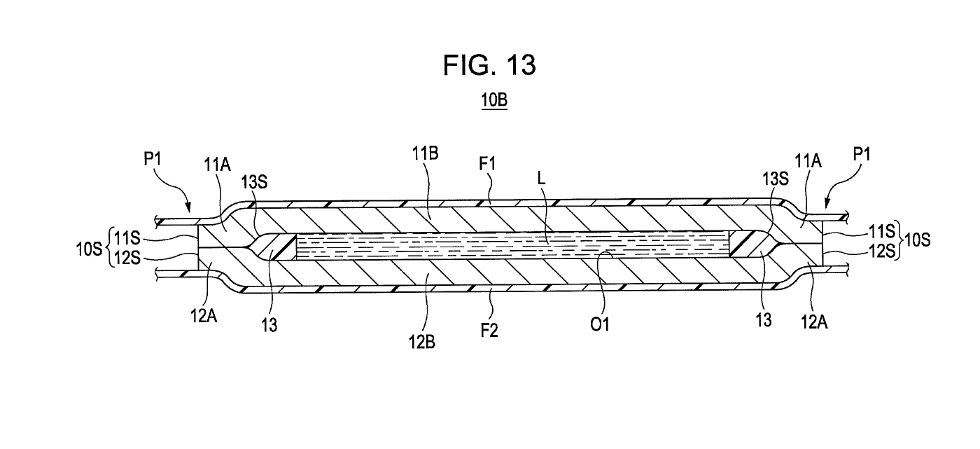

Friction generated by the ultrasonic vibrations heats the first substrate inlet portion 11B and the second substrate inlet portion 12B to a temperature in the range of approximately 180° C. to 200° C., locally welding parts of the first substrate inlet portion 11B and the second substrate inlet portion 12B corresponding to the pressure blocks 101b and 103b. Thus, as illustrated in FIG. 13, the welded portions P1 are formed in the liquid crystal inlet portion 10B. This is hereinafter referred to as first welding. The friction also locally fuses the portions of the first resin film F1 and the second resin film F2 corresponding to the pressure blocks 101b and 103b, thereby welding these portions to the outer surfaces of the first substrate inlet portion 11B and the second substrate inlet portion 12B.

Thus, in the welding process described above, the parts of the first substrate inlet portion 11B and the second substrate inlet portion 12B extending along the outsides of the sealants 13, that is, the parts containing no liquid crystal L are locally heated. This can reduce heating of the liquid crystal L, thereby preventing the generation of air bubbles in the liquid crystal L. The welded portions P1 of the first substrate inlet portion 11B and the second substrate inlet portion 12B are sometimes cloudier than their surrounding area because of the influence of heating.

After the first upper welding head 101 is removed from the liquid crystal inlet portion 10B, the second upper welding head 102 is placed above the liquid crystal inlet portion 10B. Likewise, after the first lower welding head 103 has been removed from the liquid crystal inlet portion 10B, the second lower welding head 104 is placed under the liquid crystal inlet portion 10B.

The first resin film F1, the second resin film F2, the first substrate inlet portion 11B, and the second substrate inlet portion 12B are then pressurized with the second upper welding head 102 and the second lower welding head 104. The second oscillator is then operated to apply ultrasonic vibrations to the pressure surfaces 102a and 104a. Friction generated by the ultrasonic vibrations heats the first resin film F1 and the second resin film F2 to a temperature in the range of approximately 120° C. to 130° C., fusing the portions of the first resin film F1 and the second resin film F2 corresponding to the pressure surfaces 102a and 104a, that is, the entire resin films F1 and F2.

Thus, the first resin film F1 and the second resin film F2 are welded together to cover the liquid crystal inlet portion 10B, forming the sealing member 16 sealing the liquid crystal inlet O1, as illustrated in FIG. 5. This is hereinafter referred to as second welding.

The portions of the first resin film F1 and the second resin film F2 corresponding to the liquid crystal inlet portion 10B are welded to the outer surface of the first substrate inlet portion 11B, the outer surface of the second substrate inlet portion 12B, and the side surfaces 10S of the liquid crystal inlet portion 10B, forming the holding portion 16A of the sealing member 16. The portions of the first resin film F1 and the second resin film F2 outside the liquid crystal inlet portion 10B are welded together to form the peripheral portion 16B of the sealing member 16.

Since the first substrate inlet portion 11B and the second substrate inlet portion 12B have a melting point in the range of approximately 130° C. to 150° C., the first substrate inlet portion 11B and the second substrate inlet portion 12B are not fused. Furthermore, since the liquid crystal L has a decomposition temperature in the range of approximately 170° C. to 180° C., no air bubble is generated in the liquid crystal L. Through these processes, the liquid crystal inlet O1 of the liquid crystal display element 10 is hermetically sealed.

In the present embodiment, the first resin film F1 and the second resin film F2 are placed above and below the liquid crystal inlet portion 10B before the first welding. However, the present embodiment is not particularly limited to this. For example, the first resin film F1 and the second resin film F2 may be placed above and below the liquid crystal inlet portion 10B after the first welding.

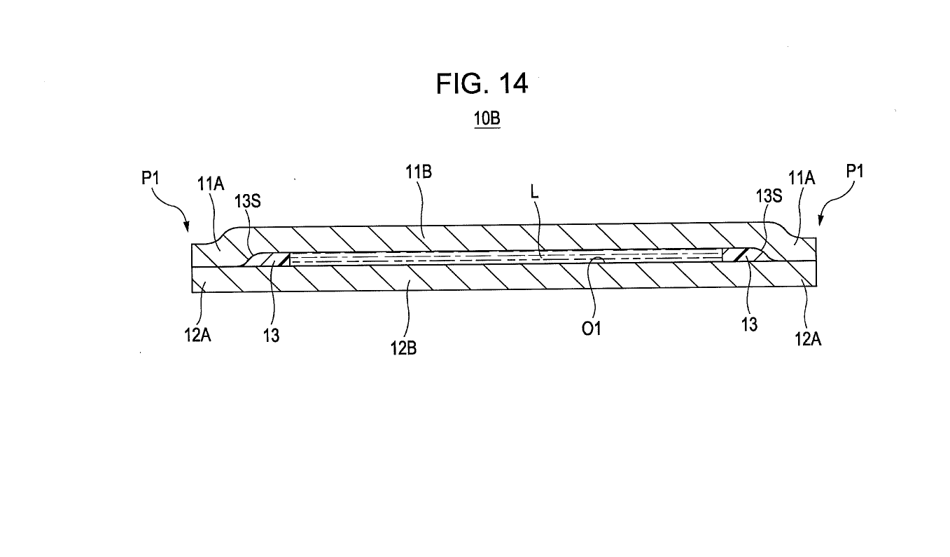

Alternatively, the first upper welding head 101 and the second lower welding head 104 may be used in combination in the first welding. In this case, the flat pressure surface 104a of the second lower welding head 104 is used in place of the first lower welding head 103. Thus, as illustrated in FIG. 14, the first substrate inlet portion 11B is mainly deformed.

Alternatively, the second upper welding head 102 and the first lower welding head 103 may be used in the first welding. In this case, the flat pressure surface 102a of the second upper welding head 102 is used in place of the first upper welding head 101. Thus, as opposed to the deformation illustrated in FIG. 14, the second substrate inlet portion 12B is mainly deformed. The sealing member 16 is omitted in FIG. 14.

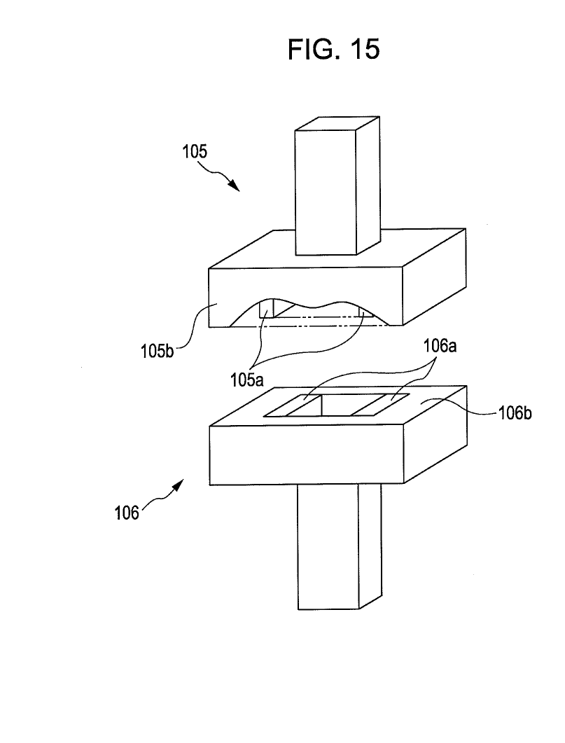

An upper welding head according to a modification of the first embodiment will be described below. FIG. 15 is a perspective view of an upper welding head 105 according to a modification of the first embodiment.

The upper welding head 105 includes first upper pressure blocks 105a and a second upper pressure block 105b. The first upper pressure blocks 105a can be used to weld the first substrate inlet portion 11B to the second substrate inlet portion 12B, forming the welded portions P1. The second upper pressure block 105b can be used to weld the first resin film F1 to the second resin film F2, thereby sealing the liquid crystal inlet O1.

The first upper pressure blocks 105a have a shape and dimensions corresponding to those of the two pressure blocks 101b of the first upper welding head 101. The second upper pressure block 105b has a quadrilateral hole in which the first upper pressure blocks 105a are disposed. The first upper pressure blocks 105a are connected to a first oscillator (not shown), and the second upper pressure block 105b is connected to a second oscillator (not shown).

A lower welding head 106 includes first lower pressure blocks 106a and a second lower pressure block 106b. The first lower pressure blocks 106a can be used to weld the first substrate inlet portion 11B to the second substrate inlet portion 12B, forming the welded portions P1. The second lower pressure block 106b can be used to weld the first resin film F1 to the second resin film F2, thereby sealing the liquid crystal inlet O1. The first lower pressure blocks 106a have a shape and dimensions corresponding to those of the two pressure blocks 103b of the first lower welding head 103. The second lower pressure block 106b has a quadrilateral hole in which the first lower pressure blocks 106a are disposed. The first lower pressure blocks 106a are connected to a first oscillator (not shown), and the second lower pressure block 106b is connected to a second oscillator (not shown).

When the liquid crystal inlet O1 of the liquid crystal display element 10 is sealed using the upper welding head 105 and the lower welding head 106, the first resin film F1, the second resin film F2, the first substrate inlet portion 11B, and the second substrate inlet portion 12B are first pressurized with the upper welding head 105 and the lower welding head 106.

The first oscillator is then operated to apply ultrasonic vibrations to the first upper pressure blocks 105a and the first lower pressure blocks 106a. Friction generated by the ultrasonic vibrations heats the first substrate inlet portion 11B and the second substrate inlet portion 12B to a temperature in the range of approximately 180° C. to 200° C., locally welding parts of the first substrate inlet portion 11B and the second substrate inlet portion 12B corresponding to the first upper pressure blocks 105a and the first lower pressure blocks 106a. Thus, as illustrated in FIG. 13, the welded portions P1 are formed in the liquid crystal inlet portion 10B.

After the first oscillator is stopped, the second oscillator is operated to apply ultrasonic vibrations to the second upper pressure block 105b and the second lower pressure block 106b. More specifically, after the first oscillator has been stopped, the second oscillator is operated while the first resin film F1, the second resin film F2, the first substrate inlet portion 11B, and the second substrate inlet portion 12B are pressurized with the upper welding head 105 and the lower welding head 106. Friction generated by the ultrasonic vibrations heats the first resin film F1 and the second resin film F2 to a temperature in the range of approximately 120° C. to 130° C., fusing the portions corresponding to the second upper pressure block 105b and the second lower pressure block 106b. Thus, as illustrated in FIG. 5, the first resin film F1 and the second resin film F2 are welded together to cover the liquid crystal inlet portion 10B, forming the sealing member 16 sealing the liquid crystal inlet O1.

Thus, using the upper welding head 105 and the lower welding head 106, the liquid crystal inlet O1 can be sealed only by switching between the first oscillator and the second oscillator. This obviates the necessity of changing the upper welding head between the first welding and the second welding.

Although the upper welding head 105 and the lower welding head 106 are used in this modification, the upper welding head 105 and the first lower welding head 103, the upper welding head 105 and the second lower welding head 104, the first upper welding head 101 and the lower welding head 106, or the second upper welding head 102 and the lower welding head 106 may be used in combination.

Furthermore, although ultrasonic vibrations are utilized in the present embodiment, laser welding may also be used. In this case, a colored irradiation target may be provided on a material to be welded.

### Second Embodiment

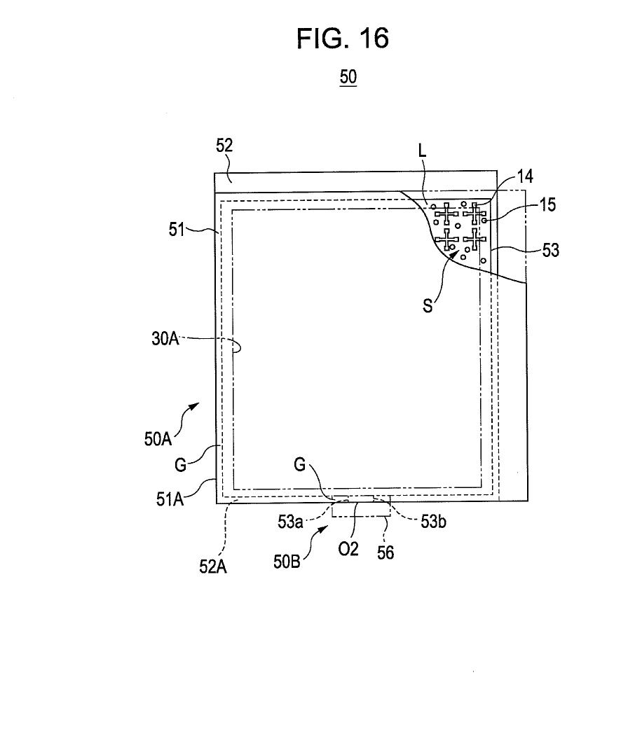

A second embodiment will be described below with reference to FIGS. 16 to 21. Like reference numerals designate like parts and will not be further described.

FIG. 16 is a partly cutaway plan view of a liquid crystal display element 50 according to the second embodiment. A liquid crystal inlet portion 50B of the liquid crystal display element 50 does not protrude from a liquid crystal display portion 50A. A peripheral region of a liquid crystal inlet O2 in the liquid crystal display portion 50A functions as the liquid crystal inlet portion 50B. A first film substrate 51 and a second film substrate 52 according to the second embodiment therefore do not have the first substrate inlet portion 11B and the second substrate inlet portion 12B described in the first embodiment.

A first end 53a and a second end 53b of a sealant 53 in the liquid crystal inlet portion 50B extend to edges of the first film substrate 51 and the second film substrate 52, thereby forming the liquid crystal inlet O2 through which the liquid crystal L is injected into a liquid crystal space S.

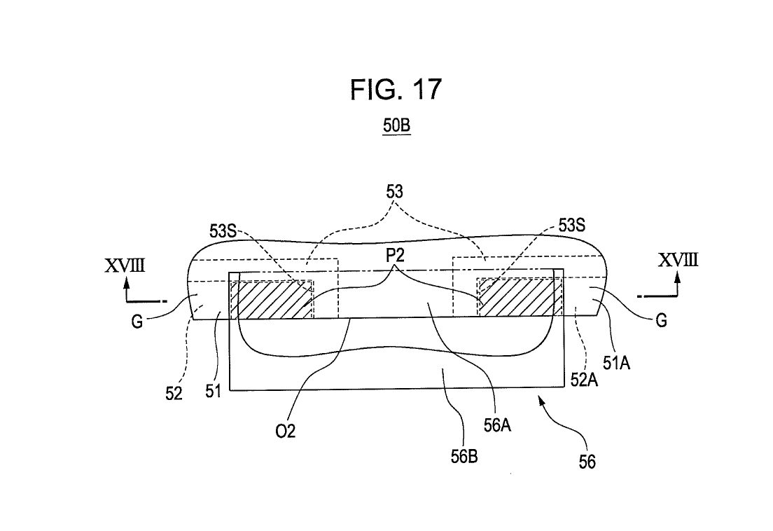

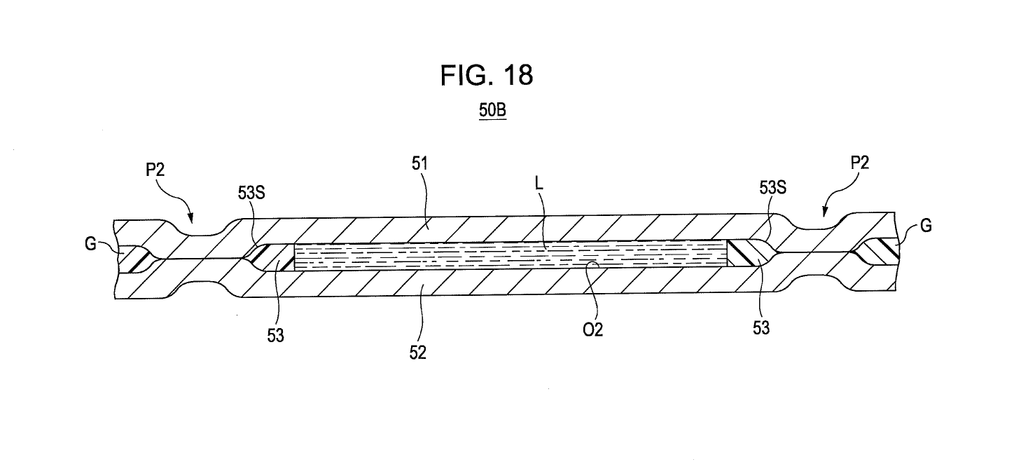

FIG. 17 is a plan view of the liquid crystal inlet portion 50B according to the second embodiment. FIG. 18 is a cross-sectional view taken along the line XVIII-XVIII in FIG. 17. A sealing member 56 is omitted in FIG. 18. As illustrated in FIG. 17 or 18, portions of the first film substrate 51 and the second film substrate 52 outside the sealant 53 are partly bent such that the first film substrate 51 comes close to the second film substrate 52. Thus, the inner surfaces of the first film substrate 51 and the second film substrate 52 adhere closely to the surface of the sealant 53 opposite the liquid crystal L, that is, an outer side surface 53S.

Portions of the first film substrate 51 and the second film substrate 52 extending outside the sealant 53 are welded together to form welded portions P2. Thus, at least in the liquid crystal inlet portion 50B, a gap G between a first substrate outer-area 51A and a second substrate outer-area 52A is sealed. The hatched areas in FIG. 17 indicate the welded portions P2 between the first substrate outer-area 51A and the second substrate outer-area 52A.

The liquid crystal inlet portion 50B of the liquid crystal display element 50 is provided with a sealing member 56 for sealing the liquid crystal inlet O2. The sealing member 56 includes a first resin film F1 and a second resin film F2 and has covering portions 56A and a peripheral portion 56B.

The covering portions 56A cover the outer surfaces of the first film substrate 51 and the second film substrate 52 so as to contain at least the liquid crystal inlet O2 and the welded portions P2. The covering portions 56A do not form a pocket and only cover the first film substrate 51 and the second film substrate 52. The peripheral portion 56B is formed by welding the first resin film F1 to the second resin film F2 and surrounds the covering portions 56A.

The inner surfaces of the covering portions 56A are welded to the outer surface of the first film substrate 51 and the outer surface of the second film substrate 52, hermetically sealing the liquid crystal inlet O2. This can prevent the leakage of the liquid crystal L from the liquid crystal space S and the flow of the outside air into the liquid crystal space S.

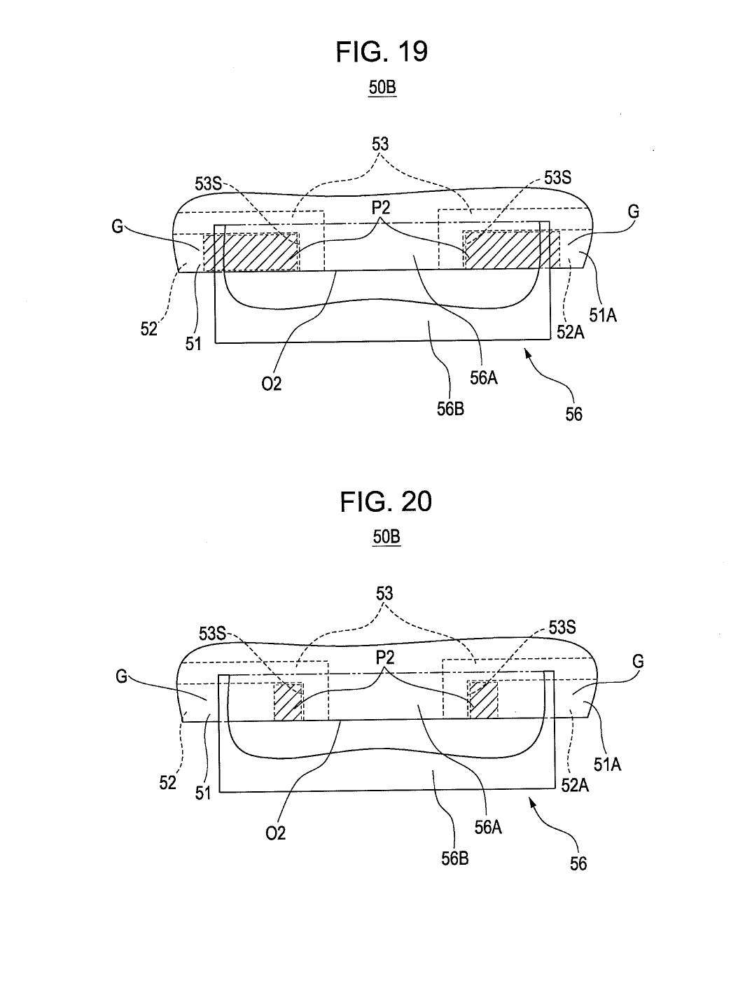

Although the welded portions P2 are formed inside the covering portions 56A of the sealing member 56 in the present embodiment, the present embodiment is not limited to this structure. FIG. 19 is a plan view of a liquid crystal inlet portion 50B according to a modification of the second embodiment. As illustrated in FIG. 19, the welded portions P2 may extend from the inside to the outside of the covering portions 56A of the sealing member 56. The welded portions P2 are not necessarily formed throughout the whole area covered with the covering portions 56A of the sealing member 56.

FIG. 20 is a plan view of a liquid crystal inlet portion 50B according to another modification of the second embodiment. As illustrated in FIG. 20, the welded portions P2 may be partly formed in the area covered with the covering portions 56A of the sealing member 56.

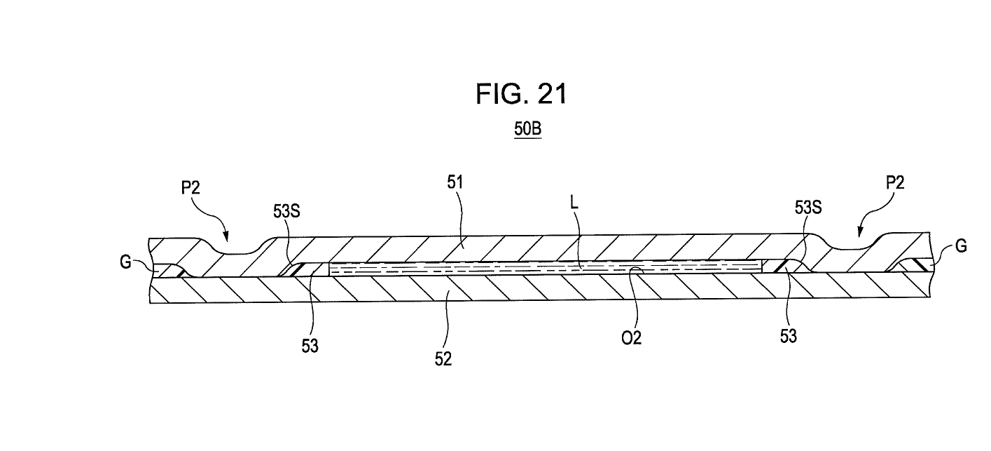

Also in the present embodiment, depending on the combination of welding heads, the first film substrate 51 may be mainly deformed as illustrated in FIG. 21. Alternatively, as opposed to the deformation illustrated in FIG. 21, the second film substrate 52 may be mainly deformed. The sealing member 56 is omitted in FIG. 21.

Although electronic paper has been described, the present embodiments are not limited to electronic paper. Provided that two substrates for containing a liquid crystal are made of a weldable resin, such as a thermoplastic resin, these embodiments may be applied to any liquid crystal display element including the two substrates.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A liquid crystal display apparatus comprising:
a first substrate and a second substrate facing each other;
a liquid crystal disposed between the first substrate and the second substrate;
a sealant provided between the first substrate and the second substrate, the sealant defining a space in which the liquid crystal is contained and an opening in communication with the space in association with the first substrate and the second substrate; and
a sealing film covering the opening and including a first portion bonded to a surface of the first substrate and a second portion bonded to a surface of the second substrate,
wherein portions of the first substrate and the second substrate are welded together, the portions being located on an opposite side to the opening with respect to the opening and being covered with the sealing film.

2. The liquid crystal display apparatus according to claim 1, wherein the sealing film has a lower melting point than the first substrate and the second substrate.

3. The liquid crystal display apparatus according to claim 1, wherein the sealing film has a melting point lower than a decomposition temperature of the liquid crystal.

4. The liquid crystal display apparatus according to claims 1, wherein
the first substrate includes a first body portion and a first protruding portion protruding from the first body portion,
the second substrate includes a second body portion facing the first body portion and a second protruding portion protruding from the second body portion and facing the first protruding portion, and
the opening is disposed between the first protruding portion and the second protruding portion.

5. A method for manufacturing a liquid crystal display apparatus, the method comprising:
bonding a first substrate and a second substrate with a sealant to form a space in which a liquid crystal is to be contained and an opening through which the liquid crystal is to be injected into the space;
injecting the liquid crystal into the space through the opening;
covering the opening with a sealing film;
welding portions of the first substrate and the second substrate, the portions being located on an opposite side to the opening with respect to the sealant and being covered with the sealing film; and
fixing the sealing film to the first substrate and the second substrate by both of bonding a first portion of the sealing film to a surface of the first substrate and bonding a second portion of the sealing film to a surface of the second substrate.

6. The method for manufacturing a liquid crystal display apparatus according to claim 5, wherein the portions of the first substrate and the second substrate are selectively heated in the welding portions.

7. The method for manufacturing a liquid crystal display apparatus according to claim 5, wherein the sealing film is fixed to the first substrate and the second substrate by both of welding the first portion to the surface of the first substrate and welding the second portion to the surface of the second substrate.

8. The method for manufacturing a liquid crystal display apparatus according to claim 7, wherein the sealing film is made of a material different from the materials of the first substrate and the second substrate.

9. The method for manufacturing a liquid crystal display apparatus according to claim 8, wherein the sealing film has a lower melting point than the first substrate and the second substrate.

10. The method for manufacturing a liquid crystal display apparatus according to claim 9, wherein the sealing film is fixed to the first substrate and the second substrate by heating the first substrate, the second substrate, and the sealing film at a temperature higher than the melting point of the sealing film and lower than the melting points of the first substrate and the second substrate.
